(19) United States
(12) Patent Application Publication
(10) Pub. No.: US 2015/0151500 A1
(43) Pub. Date: Jun. 4, 2015

(54) METHOD FOR TREATING A CONTACT LENS MOLD

(71) Applicant: Johnson & Johnson Vision Care, Inc., Jacksonville, FL (US)

(72) Inventors: Changhong Yin, St. Augustine, FL (US); Scott F. Ansell, Jacksonville, FL (US)

(73) Assignee: Johnson & Johnson Vision Care, Inc., Jacksonville, FL (US)

(21) Appl. No.: 14/095,115

(22) Filed: Dec. 3, 2013

(51) Int. Cl. B29D 11/00

(52) U.S. Cl. CPC B29D 11/00038; B29D 11/0048

(57) ABSTRACT

Disclosed in this specification is a method for treating a contact lens mold surface with ultraviolet light to increase the surface's wettability. Such molds are useful in manufacturing contact lenses by disposing a reaction mixture between a concave frontcurve mold and a convex basecurve mold prior to polymerization. By adjusting the wettability of the convex and concave surfaces, as well as the wettability of the surrounding flange, the demolding of the resulting contact lens better controlled and defects are reduced.

### FIELD OF THE INVENTION

This invention relates, in one embodiment, to a method of treating the surface of contact lens molds to increase their wettability.

### BACKGROUND

Contact lenses are manufactured by polymerizing a reaction mixture disposed between two molds which provide curved surfaces. These surfaces form the front and back surfaces of the lens. The front surface of the contact lens is formed by a concave frontcurve (FC) mold while the back surface of the contact lens is formed by a convex basecurve (BC) mold. After polymerization, the FC and BC molds are separated. The lens is then removed and subjected to subsequent processing steps (e.g. washing, hydrating, packaging and the like). The fluid mechanics that exist between the curved surface of the mold and the reaction mixture play an important role in the quality of the resulting lens. Unfortunately, methods to control these fluid mechanics are somewhat limited.

U.S. Pat. No. 4,933,123 discloses a surface treatment method for improving the printability of a surface of a polyethylene or polypropylene molded article by exposing the molded article to high energy UV light.

U.S. Pat. No. 6,737,661 discloses treating glass or quartz molds with high intensity. The duration of irradiation is disclosed to be over 90 hours.

Therefore, an improved method for treating a plastic contact lens mold is desired whereby the fluid mechanics can be better controlled.

### SUMMARY OF THE INVENTION

In one exemplary embodiment, a method for treating a contact lens mold is disclosed. The method comprises treating a curved surface of a contact lens mold with ultraviolet light wherein de-ionized water has a contact angle on the curved surface that is lower after the treating step than before the treating step.

In a second exemplary embodiment, a method for treating a plurality of frontcurve contact lens molds disposed in a carrier or pallet is disclosed. The method comprises treating the concave surfaces of the frontcurve molds disposed in the pallet with ultraviolet light wherein de-ionized water has a contact angle on the concave surface that is lower after the treating step than before the treating step. The frontcurve mold pallet includes a plurality of concave “wells” on the same side of the pallet. The frontcurve molds are seated in a “bowl up” configuration in the concave wells of the pallets.

In a third exemplary embodiment, a method of manufacturing a contact lens is disclosed. The method comprises treating a frontcurve lens mold pallet with ultraviolet light wherein de-ionized water has a contact angle on the concave surface that is lower after the treating step than before the treating step. A reaction mixture is then disposed between the treated concave frontcurve surface and the convex surface of a corresponding basecurve mold. The mixture is polymerized and the result lens is removed.

### BRIEF DESCRIPTION OF THE DRAWINGS

The present invention is disclosed with reference to the accompanying drawings, wherein:

FIG. 1 is a diagram depicting one method for making a contact lens;

FIGS. 2A and 2B are depictions of a basecurve mold and frontcurve mold, respectively, being treated with ultraviolet light;

FIGS. 3A and 3B show a lens pallet with a plurality of curved surfaces being treated with ultraviolet light; and

FIGS. 4A and 4B illustrate the use of a mask during the ultraviolet light treatment.

Corresponding reference characters indicate corresponding parts throughout the several views. The examples set out herein illustrate several embodiments but should not be construed as limiting the scope of the claims in any manner.

### DETAILED DESCRIPTION

Contact lenses, bandage lenses, intraocular lens and many other similar devices are typically made by polymerizing a reaction mixture while it is disposed between two disposable plastic molds. The reaction mixture which forms the lenses is a mixture of components including reactive components, such as monomers, macromers and crosslinkers as well as non-reactive components such as diluents, initiators, and additives. Reactive components are the components in the reaction mixture which, upon polymerization, become a permanent part of the polymer via chemical bonding, entrapment or entanglement within the polymer matrix. The reaction mixtures used in the present invention are not limited and can include any components known or disclosed to be useful for forming hydrogel and silicone hydrogel contact lenses. Examples of reactive components include HEMA (2-hydroxyetyl methacrylate); DMA (N,N-dimethylacrylamide); glycerol methacrylate, 2-hydroxyethyl methacrylamide, polyethyleneglycol monomethacrylate, methacrylic acid, acrylic acid N-vinyl pyrrolidone, N-vinyl-N-methyl acetamide, N-vinyl-N-ethyl acetamide, N-vinyl-N-ethyl formamide, N-vinyl formamide, combinations thereof and the like. Non-limiting examples of suitable silicone containing components include reactive PDMS (reactive polydialkylsiloxanes, such as mPDMS—mono(meth)acryloxypropyl terminated mono-n-butyl terminated polydimethylsiloxane with a molecular weight from 800-1000, 3-mono(meth)acryloxypropyl terminated mono-n-methyl terminated polydimethylsiloxane methacryloxypropyltris(trimethylsiloxy)silane (“TRIS”), 3-methacryloxypropylbis(trimethylsiloxy)methylsilane and

3-methacryloxypropylpentamethyl disiloxane or OH-mPDMS—mono—(3-methacryloxy-2-hydroxypropyloxy)propyl terminated, mono-butyl terminated polydimethylsiloxane). Other examples of reactive components include 2-propenoic acid, 2-methyl-,2-hydroxy-3-[3-[1,3,3,3-tetramethyl-1-[(trimethylsilyl)oxy]disiloxanyl]propoxy]propyl ester (SiGMA). The reaction mixture may further comprise additional reactive components, including, but not limited to ultraviolet absorbing components, reactive tints, pigments, photochromic compounds, release agents crosslinkers, wetting agents, initiators and the like. After benefiting from reading this specification, other reactive components would be readily apparent to one skilled in the art and such reactive components are contemplated for use with the present methods.

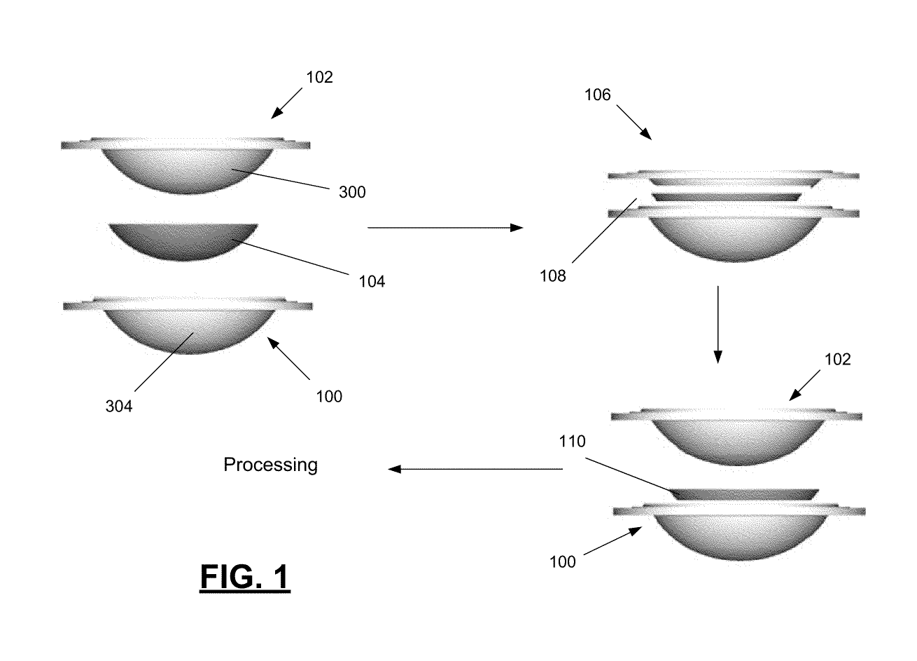

FIG. 1 is a flow diagram illustrating one method for forming contact lenses. Frontcurve (FC) mold 100 and basecurve (BC) mold 102 are shown. Frontcurve mold 100 includes a concave surface 304 for receiving reaction mixture 104. Basecurve mold 102, which has a convex surface 300, is pressed onto the top of frontcurve mold 100 to form assembly 106. The space between concave surface 304 and convex surface 300 defines mold cavity 108, which holds reaction mixture 104. Mold cavity 108 is sized and shaped to form a contact lens. While molds 100, 102 are pressed together with reaction mixture 104 disposed therebetween, a polymerization reaction is initiated that transforms reaction mixture 104 to cured lens 110. In one embodiment, the polymerization reaction is initiated photochemically (e.g. ultraviolet light).

Basecurve mold 102 is sized and shaped to permit the resulting back surface of cured lens 110 to rest on the cornea of an eye. The convex surface 300 is designed to pass light and/or heat into the reaction mixture 104, thereby permitting its polymerization to be initiated. In one embodiment, the convex surface 300 is transparent to ultraviolet light. Similarly, the frontcurve mold 100 is sized and shaped to form the front surface of the resulting cured lens 110.

After polymerization is complete molds 100, 102 are separated from one another and the resulting cured lens 110 is demolded. Cured lens 110 is subsequently subjected to additional processing steps (e.g. washing, aqueous hydration, sterilization, and packaging). In one embodiment, plastic molds 100, 102 are single-use (disposable) molds.

A number of defects can occur during the production of contact lenses. These defects include lens holes, chips/tears, formation of rings of excess polymer around the edge of the lens, called flash-rings and lost lenses during demolding or processing. Such defects may be present in 10-20% of the lenses produced according to prior art techniques. Lens hole defects include voids (holes in the lens), pits (non-uniform lens thickness) and uneven edges. Tears are rips in the lens. Chips are segments of the lens which are ripped away. Flash-rings occur when the reaction mixture overflows onto the flanges of the frontcurve lens and subsequently polymerize. This overflow can occur, for example, when the frontcurve and backcurve molds are pressed together.

Each of these defects is the result of a myriad of complex, interacting parameters. For example, lens holes can be minimized by increasing the volume of reaction mixture but this increased volume promotes formation of flash-rings. The parameters that can effect these defects include the fluid mechanics between reaction mixture 104 and frontcurve mold 100 and backcurve mold 102. Another parameter is the adhesion between the cured lens 110 and frontcurve mold 100 and backcurve mold 102. Many of these parameters are related to the surface energy of the respective mold.

Reaction mixtures and cured hydrogel lenses generally adhere more strongly to high energy (more wettable) surfaces. Basecurve molds are typically formed from hydrophobic (low surface energy, high contact angle) plastics to minimize the interfacial interaction between the reaction mixture (and the resulting cured lens) and the basecurve mold. Examples of suitable basecurve plastics include polyolefins (e.g. polypropylene, PP); cyclic olefin polymer (COP, including Zeonor 1060R) and copolymer (such as ethylene-cyclic olefin copolymers sold as Topas); polystyrene (PS), hydrogenated styrene-butadiene copolymers (for examples those sold as Tuftec), blends thereof and the like. In one embodiment the basecurve materials is selected from cyclic olefin polymer, cyclic olefin copolymer, hydrogenated styrene-butadiene copolymers and copolymers and blends thereof. In another embodiment, where copolymers of the foregoing are used the amount of the copolymer is less than about 40 wt % and in some embodiments less than about 20 wt %.

In one embodiment the backcurve contains less than 15 wt %, and in another embodiment is free of wetting agents such zinc stearate which may minimize the effect of the present invention.

Prolonged exposure to UV light, particularly at distances less than 20 mm and unlike glass or quartz molds, plastic mold parts may be deformable when heated. Accordingly, treatment times of the present invention are desirably less than 5 minutes, less than one minute and in some embodiments less than about 30 seconds.

Frontcurve molds are generally formed from materials that are more wettable (high surface energy, low contact angle) than their corresponding basecurve mold. Unfortunately, this places constraints on the variety of suitable frontcurve molds that are available. Additionally, certain machinery requires the frontcurve and basecurve molds be formed from the same material. In such circumstances, it is not possible to use a frontcurve mold that is made from a different polymer that the corresponding basecurve mold.

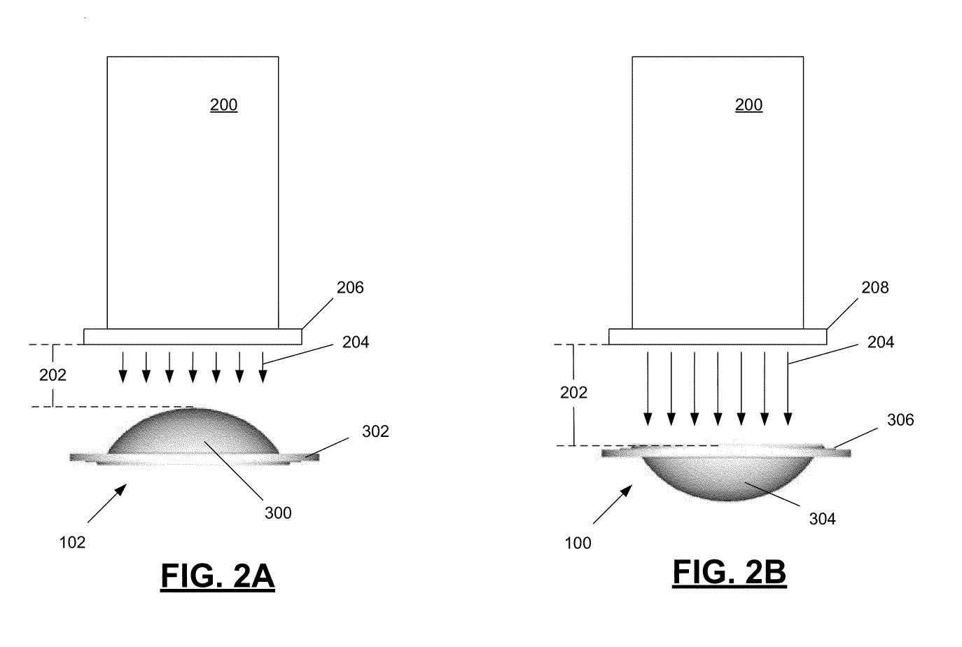

Referring now to FIGS. 2A and 2B, mold surface is shown undergoing treatment. FIG. 2A illustrates the treatment of basecurve mold 102 while FIG. 2B depicts the treatment of frontcurve 100 mold. The surface energy (as measured in this invention by contact angle) of the concave surface 304, convex surface 300, or both the concave and convex surfaces are increased by treating the respective surface(s) with ultraviolet radiation.

In FIG. 2A, a light source 200 and filter 206 are disposed at a distance 202 above the convex surface 300 of basecurve mold 102. Light source 200 may be, for example, an Omnicure brand Series 2000 UV curing system available from Lumen Dynamics. Distance 202 may be, for example, 0 mm to 20 mm. The power of the light source 200 and the magnitude of distance 202 may be adjusted to deliver sufficient ultraviolet light 204 to convex surface 300 such that its surface energy is increased. Filter 206, which is used in the treatment of basecurve mold 302, may be the same or different as filter 208, which is used in the treatment frontcurve mold 306. Filter 206 is selected to deliver a predetermined wavelength or range of wavelengths of ultraviolet light to the basecurve mold 102 with a predetermined power rating. In one embodiment, filter 206 passes wavelengths between 250-500 nm or any subrange therebetween. In another embodiment, filter 206 passes wavelengths between 320-500 nm or a subrange therebetween. In yet another embodiment, filter 206 passes wavelengths between 320-500 nm or a subrange therebetween. The power rating of ultraviolet light 204 delivered to convex surface 300 is generally between 5000 mW/cm² and 25000 mW/cm² and in some embodiments between about 10,000 and 25,000 mW/cm². Convex surface 300 is irradiated for a period of time greater than zero seconds but less than one minute. In another embodiment, the period of irradiation is greater than five seconds but less than thirty seconds. In yet another embodiment, the period of irradiation is greater than five seconds but less than seventeen seconds. Exemplary power ratings associated with a commercially available filter/light sources are shown below:

TABLE 1
Exemplary power ratings

| | |
|---|---|
| Wavelength | Power Rating |

| | | | |
|---|---|---|---|
| 320-500 | nm | 23,400 | mW/cm² |
| 400-500 | nm | 8,700 | mW/cm² |
| 320-390 | nm | 11,100 | mW/cm² |
| 365 | nm | 6,000 | mW/cm² |
| 250-450 | nm | 24,600 | mW/cm² |

The use of ultraviolet light to modify the surface energy of a polymeric material carries a number of advantages over prior art methods. The use of ultraviolet light is less expensive than chemical modification and results in a less expensive product. Additionally, ultraviolet treatment is safer and easier to control than previous techniques (e.g. plasma etching) and permits highly targeted surface treatments of molds where only select portions of the mold surface are modified.

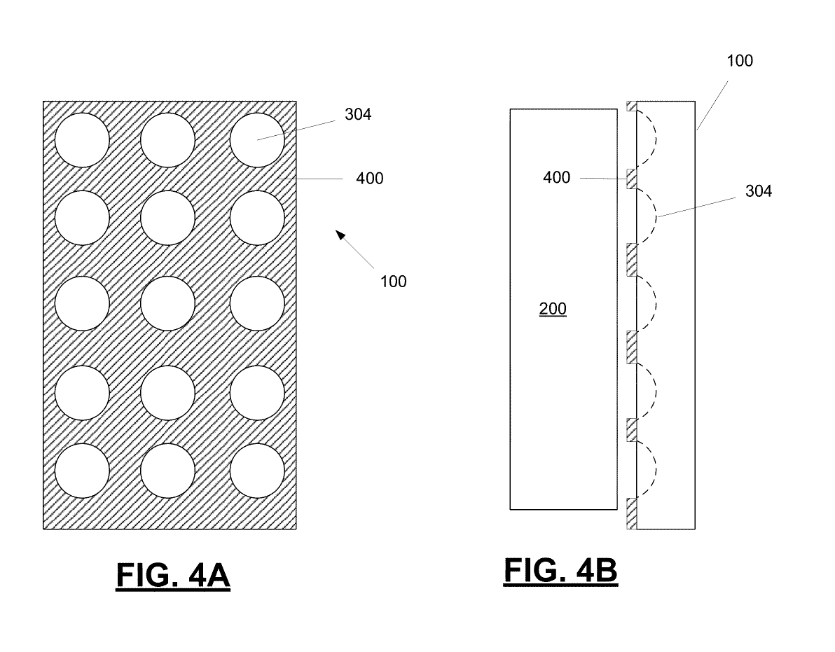

In one embodiment, convex surface 300 is irradiated without irradiating basecurve flange 302. Referring to FIG. 2A, by placing light source 200 at a certain distance from convex surface 300, the convex surface 300 is irradiated while the basecurve flange 302 that surrounds the convex surface 300 is not irradiated. A corresponding irradiation may be performed on concave surface 304 (FIG. 2B). Advantageously, this permits a user to selectively and individually tune the surface properties, including wettability of each of convex surface 300, concave surface 304, basecurve flange 302 and/or frontcurve flange 306. Thus, a desired degree of wettability can be determined for each such component and selective irradiation is then performed to render the desired degree of wettability. For example, basecurve flange 302 and/or frontcurve flange 306 have a first degree of wettability. The wettability of concave surface 304 may be increased to a second degree, higher than the first degree, by high-power irradiation. Likewise, the wettability of concave surface 300 may be increased to a third degree, higher than the first and second degrees. In another embodiment, the wettability of concave surface 300 may be increased to a third degree that is higher than the first degree but the same as the second degree. The wettability of basecurve flange 302 and/or frontcurve flange 306 may or may not be increased using irradiation. In one embodiment, the wettability of basecurve flange 302 and/or frontcurve flange 306 are only marginally increased by incidental irradiation during the irradiation of the corresponding concave or convex surface. In one embodiment, this incidental irradiation is minimized using a mask 400 (see FIGS. 4A and 4B) which is optically opaque to the wavelength of ultraviolet light used to perform the irradiation. Mask 400 may be permanently affixed to the mold or, in another embodiment, is present only during the irradiation and subsequently removed. Mask 400 may be used with either the frontcurve mold 100, the basecurve mold 102 or both. Mask 400 is also useful when a single light source 200 is used or irradiate multiple curved surfaces on a single frame. See FIG. 4B.

In another embodiment the backcurve flange may be selectively irradiated to increase the wettability of the backcurve flange and allow any flash ring to selectively bias during demolding to the treated backcurve flange instead of the untreated frontcurve mold flange.

In one embodiment the contact angle of at least a portion of the convex surface of the basecurve is reduced by 1° to 20°, 5° to 30°, 5° to 20°.

In one embodiment, the entire surface of frontcurve mold 100 and/or backcurve mold 102 are irradiated uniformly. Each mold 100, 102 may be irradiated to a same or a different extent. In another embodiment, the surfaces of molds 100, 102 are selectively irradiated to treat the convex surface 300 and concave surface 304 differently than the corresponding flanges 302, 306.

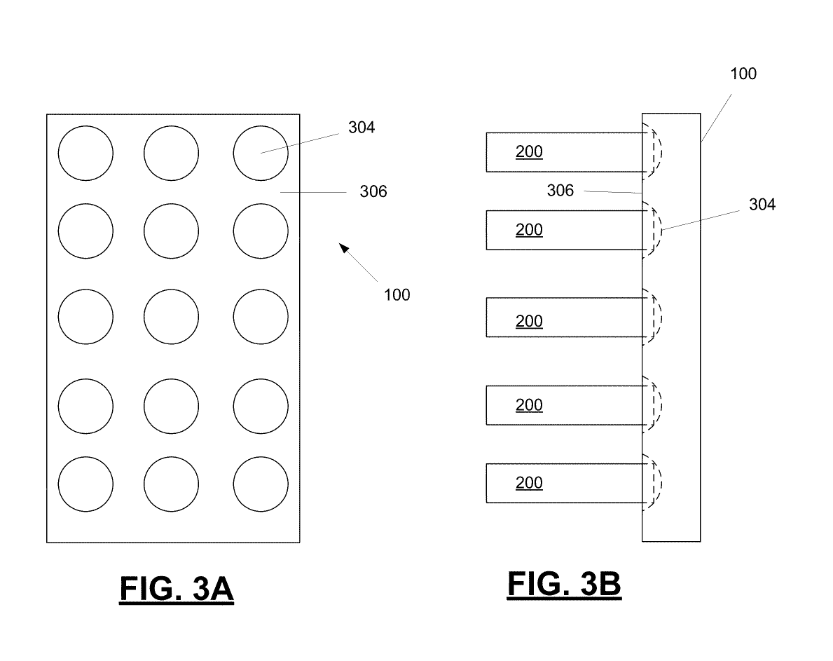

Referring to FIG. 3A, an exemplary frontcurve pallet 100 is shown which includes a plurality of concave surfaces or wells 304. In FIG. 3A, fifteen such surfaces are shown, although the precise number can vary. Each concave surface 304 is disposed on the same side of the frontcurve pallet 100 and each is separated from the other concave surfaces by a flange 306 which, in the embodiment depicted, is planar. Frontcurve molds (not shown) are seated in a “bowl up” configuration in each of the concave wells of the pallets. The frontcurve molds may be formed from any suitable plastic, including traditionally hydrophobic plastics such as polyolefines such as polypropylene, cyclic olefin polymers and copolymers, polystyrene, blends thereof and blends with other polymers among others. In FIG. 3B, a plurality of light sources 200 are each arranged to irradiate a corresponding mold seated in the concave surface 304 of the pallet. In the embodiment depicted, light sources 200 are 0 mm away from concave surfaces 304 (i.e. they are touching). In another embodiment, the distance is greater than 0 mm.

Ultraviolet light is irradiated from light sources 200 to increase the surface energy of concave surfaces 304 of the frontcurve mold. In the embodiment depicted in FIG. 3B, frontcurve flanges are not irradiated and retain a relatively low surface energy. When reaction mixture 104 (shown in FIG. 1) contacts the treated concave surface 304, its higher surface energy promotes uniform spreading of the reaction mixture 104 (which reduces lens holes) without requiring the use of an excessive volume of reaction mixture 104. The reduced volume of reaction mixture also results in a cost savings. Should the reaction mixture overflow onto frontcurve flange (shown as 306 in FIG. 2B), its relatively high surface energy promotes beading of the reaction mixture which reduces flash-rings.

In a similar process shown in FIG. 2A, light sources 200 are used to irradiate the convex surfaces 300 of basecurve mold 102. Like frontcurve mold 100, the convex surface 300 and basecurve flange 302 may be selectively irradiated to product a convex surface 300 with a higher surface energy relative to the surrounding basecurve flange 302. By treating the frontcurve mold 100 and basecurve mold 102 separately, the wettability of each section (300, 302, 304 and 306) can be individually tuned to a desired surface energy. This can be achieved even when both frontcurve mold 100 and basecurve mold 102 of formed of the same polymeric material. Additionally, frontcurve mold 100 can be formed from a hydrophobic polymeric material which is atypical for a frontcurve mold. In another embodiment the concave surface of both the frontcurve and backcurve molds are irradiated with UV light. In this embodiment, the non-molding concave surface of the backcurve mold is treated. The UV light does not substantially alter the properties of the convex surface of the backcurve mold which is disposed away from the UV light. In this way, front and backcurve molds of the same material may be treated to provide front and backcurve molds with molding surfaces having different surface energies, as measured by contact angle.

In the following examples, the surface energy of the convex surface of several basecurve molds were determined by measuring the sessile drop contact angle of de-ionized water on the surface. The angles were measured using a PG-X goniometer, available Thwing-Albert Instrument Company in West Berlin, N.J.

Surface wettability of the treated molds can be determined using a sessile drop contact angle technique using a PG-X goniometer at room temperature and using DI water as probe liquid. Each test mold lens was placed on a sample holder with the convex side up. The mold together with the holder is placed in the sessile drop instrument sample stage, ensuring proper centering of needle to deliver the water droplet. A 4 microliter of DI water droplet was generated using a PG-X goniometer ensuring that the liquid drop was hanging away from the mold. The droplet was made in contact with the mold surface by raising the stage upwards. The liquid droplet was allowed to equilibrate on the mold surface for 1-3 seconds and the contact angle was determined using the built-in analysis software.

### Comparative Example 1—0 Seconds, 0 mm Distance-Control

The convex surface of a basecurve mold formed from Zeonor 1060R COP was subjected to a contact angle measurement with de-ionized water. The contact angle was 95°.

### Examples 1-30 mm Distance

The convex surface of a basecurve mold (1 per set of conditions) formed from Zeonor 1060R COP was treated with an OmniCure 2000 UV Curing System (filter 320-500 nm, 23,400 mW/cm² power rating) with the filter of the light source and the convex surface of the molds touching (distance=0 mm). The treatment time is shown in Table 2. The contact angle of the resulting treated convex surface was measured and are shown in Table 2.

| Ex. # | Time (sec) | Contact angle ° |
|---|---|---|
| CE1 | 0 | 95 |
| 1 | 4 | 88 |
| 2 | 7 | 70 |
| 3 | 10 | 66 |

### Comparative Example 20 Seconds, 17 mm Distance

A basecurve mold formed from Zeonor 1060R COP was subjected to a contact angle measurement with de-ionized water. The experiment was repeated at least four times. The average contact angle was 96°.

### Example 4—17 Seconds, 17 mm Distance

A basecurve mold formed from Zeonor 1060R COP was treated with an OmniCure 2000 UV Curing System (Filter 320-500 nm, 23400 mW/cm² power rating) with the filter of the light source and the convex surface 17 mm apart for 17 seconds. The resulting treated convex surface was subjected to a contact angle measurement with de-ionized water. The experiment was repeated at least four times. The average contact angle was 90 degrees compared to 96° for the control in Comparative Example 2.

### Example 5—10 Seconds, Variable Distance

A basecurve mold formed from Zeonor 1060R COP was treated with an OmniCure 2000 UV Curing System (320-500 nm, 23400 mW/cm2 power rating) with the filter of the light source and the convex surface at variable distances for 10 seconds. The resulting treated convex surfaces were subjected to a contact angle measurement with de-ionized water. The contact angles were as follows:

TABLE 4
Distance effects (10 seconds)

| Distance | Contact angle |
|---|---|
| 0 mm | 63 ± 1 |
| 9 mm | 86 ± 2 |
| 14 mm | 88 ± 2 |
| 17 mm | 90 ± 1 |
| 21 mm | 93 ± 1 |

### Example 6—Variable Time, 0 mm and 17 mm Distance

The convex surfaces of basecurve molds formed from Zeonor 1060R COP were treated with an OmniCure 2000 UV Curing System (320-500 nm, 23400 mW/cm² power rating) with the filter of the light source and the convex surface at 10 and 17 mm distances for variable periods of time. The resulting treated convex surfaces were subjected to a contact angle measurement with de-ionized water. The contact angles were as follows:

TABLE 5
Distance effects (10 seconds)

| Time | Contact Angle (10 mm) | Contact Angle (17 mm) |
|---|---|---|
| 0 | 95 ± 1 | 95 ± 1 |
| 0.5 | 93 ± 4 | NM |
| 1 | 92 ± 3 | NM |
| 2 | 92 ± 4 | NM |
| 2.5 | NM | 95 ± 1 |
| 5 | 90 ± 3 | 93 ± 1 |
| 7 | 75 ± 1 | NM |
| 7.5 | NM | 88 ± 1 |
| 10 | 68 ± 2 | 90 ± 1 |
| 15 | 64 ± 2 | 88 ± 1 |
| 20 | 63 ± 4 | 88 ± 2 |
| 25 | 61 ± 1 | 86 ± 2 |
| 30 | 64 ± 1 | 81 ± 1 |
| 45 | 62 ± 3 | NM |

NM = Not Measured

While the methods have been described with reference to specific embodiments, it will be understood by those skilled in the art that various changes may be made and equivalents may be substituted for elements thereof to adapt to particular situations without departing from the scope of the claims. Therefore, it is intended that the claims not be limited to the particular embodiments disclosed as the best mode contemplated for carrying out these methods, but that the claims will include all embodiments falling within the scope and spirit of the appended claims.

What is claimed is:

1. A method for treating a contact lens mold comprising the step of treating a curved molding surface of a plastic contact lens mold with ultraviolet light to produce a treated curved molding surface wherein de-ionized water has a contact angle on the treated curved molding surface that is lower after the treating step than before the treating step.

2. The method as recited in claim 1, wherein the treating step irradiates the curved molding surface with ultraviolet light with at least one wavelength between 250 nm and 500 nm at an intensity of at least 5000 mW/cm² to produce the treated mold.

3. The method as recited in claim 2, wherein the treating step irradiates the curved surface with ultraviolet light for a period of time greater than zero seconds and less than thirty seconds.

4. The method as recited in claim 1, wherein the ultraviolet light is emitted by a light source, the method further comprising the step of disposing the light source within 20 mm of the curved surface.

5. The method as recited in claim 1, wherein the ultraviolet light is emitted by a light source, the method further comprising the step of disposing the light source within 10 mm of the curved surface.

6. The method as recited in claim 1, wherein the contact lens mold further comprises a flange circumscribing the curved surface, wherein de-ionized water has a contact angle on the flange that is different than the contact angle on the curved molding surface after the step of treating the curved surface, thereby providing different surface energies on the flange and the curved molding surface, respectively.

7. The method as recited in claim 1, wherein the contact lens mold is selected from the group consisting of (a) a frontcurve mold wherein the curved molding surface is a concave surface, (b) a basecurve mold wherein the curved molding surface is a convex surface.

8. The method as recited in claim 1, wherein the contact angle of de-ionized water on the treated curved molding surface is at least ten degrees lower after the treating step than before the treating step.

9. The method as recited in claim 1, wherein a plurality of lens molds are disposed in a pallet with, each curved molding surface being disposed on a first side of the pallet and being separated from one another by a flange.

10. A method for treating a pallet comprising a plurality of frontcurve molds, each of said frontcurve molds comprising a concave molding surface for contact lenses comprising the step of treating at least one concave molding surface with ultraviolet light to produce a treated concave molding surface wherein de-ionized water has a contact angle on the treated concave surface that is lower after the treating step than before the treating step, the plurality of frontcurve molds being disposed on a first side of the pallet, the concave molding surfaces being separated from one another by a frontcurve flange.

11. The method as recited in claim 10, wherein the frontcurve mold is formed of a hydrophobic polymeric material selected from the group consisting of polyolefin, cyclic olefin polymer, cyclic olefin copolymer, polystyrene and blends, copolymers thereof.

12. The method as recited in claim 10, the method further comprising the step of treating at least one basecurve convex molding surface among a plurality of basecurve convex molding surfaces disposed on a basecurve pallet with ultraviolet light to produce a treated convex molding surface wherein de-ionized water has a contact angle on the treated convex surface that is lower after the treating step than before the treating step, the convex surfaces being circumscribed, and separated from one another by a basecurve flange.

13. The method as recited in claim 12, wherein the frontcurve mold and the basecurve mold are formed of the same polymeric material.

14. The method as recited in claim 10, further comprising the steps of:
determining a desired degree of wettability for the concave surface and thereafter;
performing the step of treating to give the concave surface the desired degree of wettability.

15. A method for manufacturing a contact lens comprising the steps of:
providing a contact lens assembly that includes
a frontcurve pallet with a plurality of concave wells disposed on a first side of the frontcurve pallet each well comprising a frontcurve lens mold comprising a concave molding surface and each lens mold being separated from the others by a frontcurve flange;
a basecurve pallet with a plurality of convex surfaces disposed on a first side of the basecurvepallet, each convex surface being separated from the others by a basecurve flange;
treating at least one concave surface among the plurality of concave surfaces of the frontcurve pallet with ultraviolet light to produce a treated concave molding surface wherein de-ionized water has a contact angle on the treated concave molding surface that is lower after the treating step than before the treating step;
disposing a reaction mixture in the treated concave molding surface;
placing a basecurve mold having a convex molding surface on each frontcurve mold such that the reaction mixture is between, and in contact with, both the concave molding surface and the convex molding surface;
polymerizing the reaction mixture to form a contact lens; and
removing the contact lens from the contact lens assembly.

16. The method as recited in claim 15, wherein the ultraviolet light is emitted by a light source, the method further comprising the step of disposing the light source within 10 mm of the curved surface during the treating step.

17. The method as recited in claim 15, further comprising the step of treating at least one convex surface among the plurality of convex surfaces of the basecurve mold frame with ultraviolet light to produce a treated convex surface wherein de-ionized water has a contact angle on the treated convex surface that is lower after the treating step than before the treating step, the plurality of convex surfaces being disposed on a first side of the basecurve mold frame, the convex surfaces being circumscribed, and separated from one another by a basecurve flange.

18. The method as recited in claim 17, wherein the frontcurve mold and the basecurve mold are formed of the same polymeric material.

19. The method as recited in claim 15, wherein the treating step irradiates the concave surface with ultraviolet light for a period of time greater than zero seconds and less than thirty seconds.

20. The method as recited in claim 15, wherein de-ionized water has a contact angle on the frontcurve flange that is different than the contact angle on the treated concave, thereby providing different surface energies on the flange and the treated concave surface, respectively.

21. A method for treating a basecurve mold frame for contact lenses comprising the step of treating at least one convex surface among a plurality of convex surfaces of a plastic backcurve mold frame with ultraviolet light to produce a treated convex surface wherein de-ionized water has a contact angle on the treated convex surface that is lower after the treating step than before the treating step, the plurality of convex surfaces being disposed on a first side of the backcurve mold frame, the convex surfaces being separated from one another by a frontcurve flange.

22. The method as recited in claim 12 or 17, wherein the frontcurve mold and the basecurve mold are formed of different polymeric materials.
